(19) United States
(12) Patent Application Publication
(10) Pub. No.: US 2010/0072008 A1
(43) Pub. Date: Mar. 25, 2010

(54) METHOD AND PROCESS FOR APPLICATION AND DETECTION OF ANTIOXIDANT PAINTS/PENETRANTS FOR CARBON-CARBON BRAKE DISCS

(76) Inventors: Manuel G. Koucouthakis, Granger, IN (US); Laurie A. Booker, South Bend, IN (US); Michelle L. Shreve, South Bend, IN (US); Terence B. Walker, South Bend, IN (US)

Correspondence Address: HONEYWELL/BSKB;PATENT SERVICES, 101 COLUMBIA ROAD, P.O. BOX 2245, MORRISTOWN, NJ, 07962-2245, US

(21) Appl. No.: 12/236,580

(22) Filed: Sep. 24, 2008

(51) Int. Cl. F16D 65/12; C09D 1/00

(52) U.S. Cl. 188/218 XL; 106/14.05

(57) ABSTRACT

Brake disc with carbon composite body, wherein the surface of the brake disc is at least partially covered by a layer of an antioxidant composition that can be visualized by viewing it under “blacklight”. The brake disc of may be processed, before being incorporated into a brake system, to remove antioxidant composition that covers the working surface of the disc. An antioxidant coating composition may include from 10-75 wt % H₂O, 20-65 wt % H₃PO₄, 0.1-20 wt % alkali metal mono-, di-, or tri-basic phosphate, 0-2 wt % hydrated boron oxide, 0-18 wt % KH₂PO₄, 3-10 wt % of a transition metal oxide, and 1-20 wt % zinc sulfide.

### FIELD OF THE INVENTION

This invention relates to the manufacture of carbon-carbon brake discs. More particularly, this invention relates to brake discs which are coated with antioxidant compositions during the course of their preparation for use in braking systems.

### BACKGROUND OF THE INVENTION

Antioxidant treatments are required to protect non-friction surfaces of carbon-carbon composite brake friction materials, due to the high operating temperatures of braking systems utilizing these materials. Combinations of phosphoric acid and various metal phosphates are commonly used for such antioxidant treatments. Unfortunately, these same materials have adverse effect on braking effectiveness. Specifically, they lower friction coefficients of the carbon-carbon composite materials to which they are applied. While this is not a problem on the non-friction surfaces of the brake discs, it is very much a problem when the antioxidant material contacts the friction surfaces thereof. Because conventional antioxidant treatments are virtually invisible on carbon-carbon composites in their cured state, accidental application thereof to the friction surface can go undetected, resulting in adverse performance of the brake friction material.

### SUMMARY OF THE INVENTION

The present invention solves this problem by enabling inspection of the painted area of a brake disc in both the as-painted and cured conditions, while maintaining the current appearance of the antioxidant system. The present invention accomplishes this by modifying standard phosphoric acid-based antioxidant systems by the addition thereto of 1-20 weight-% zinc sulfide, preferably about 5 weight-% zinc sulfide. This forms a suspension, which is painted onto the carbon-carbon brake disc in the normal manner, and which is then cured using a high temperature (700-900° C.) inert gas cure. After painting, and also after curing, the composite brake disc is exposed to ultraviolet “blacklight”. The painted area glows when exposed to the blacklight, which permits detection of undesired coverage of friction surfaces by antioxidant chemicals. The areas tainted by undesired chemicals can then be marked, and machined to remove the undesired antioxidant chemicals, leaving the entire friction surface of the carbon-carbon composite brake disc antioxidant free.

The present invention provides, in one embodiment, a brake disc comprising a carbon composite body, wherein the surface of the brake disc is at least partially covered by a layer of an antioxidant composition that can be visualized by viewing it under “blacklight”. The brake disc of the present invention may be processed, before being incorporated into a brake system, to remove antioxidant composition that covers the working surface of the disc.

Antioxidant coating compositions that can be used in this invention may include: from 10-75, preferably 20-25, wt % H₂O; from 20-65, preferably 40-45, wt % H₃PO₄; from 0.1-20 wt % alkali metal mono-, di-, or tri-basic phosphate; up to 2, preferably 1-2, wt %, hydrated boron oxide; up to 18, preferably 8-12, wt % KH₂PO₄; from 3-10 wt % of a transition metal oxide, preferably 4-7 wt % of TiO₂, more preferably 4-7 wt % CoCr₂O₄; and from 1-20 wt % zinc sulfide, preferably from 2-10 wt % zinc sulfide, most preferably about 5 wt % zinc sulfide.

This invention provides a brake disc comprising a carbon composite article, the surface of which article has been treated with an antioxidant coating as described above which contains from about 1 through about 20 weight-% of zinc sulfide, wherein said zinc sulfide is visible under blacklight.

The invention also provides a method for protecting a carbon composite friction article against oxidative weight loss, which method may include: a preliminary step of configuring the carbon composite friction article as a brake disc; a step of treating the surface of the composite article with an antioxidant coating which contains from about 1 through about 20 weight-% of zinc sulfide, wherein the antioxidant coating is visible under blacklight; and a subsequent step of removing, for instance by machining or by abrasion with a wire brush, said antioxidant coating from a friction surface of the brake disc.

### BRIEF DESCRIPTION OF THE DRAWINGS

The present invention is illustrated by the drawings submitted herewith. The drawings are not to scale, and are submitted for the purpose of illustrating, but not limiting, certain aspects of the invention.

FIG. 1 illustrates a brake disc in accordance with the present invention.

FIG. 2 illustrates a brake disc that has been manufactured from a brake disc of the present invention.

### DETAILED DESCRIPTION OF THE INVENTION

The present invention provides a brake disc comprising a carbon composite body. Methods of manufacturing carbon-carbon composites configured as brake discs are well known in industry, as discussed hereinbelow. The surface of carbon composite body in accordance with this invention has been treated with a coating that protects the carbon composite against oxidative weight loss and that is visible under blacklight.

The feature “protection against oxidative weight loss” does not indicate absolute protection against any weight loss, but instead indicates reduction in weight loss as compared to an otherwise identical carbon composite that is not coated. For instance, after oxidation for 24 hours at 1200° F., weigh losses of up to 5% would be acceptable, with weight losses of not more than approximately 1.5% being preferred. Likewise, after oxidation for 6 hours at 1600° F., weigh losses of up to 20% would be acceptable, with weight losses of not more than approximately 15% being preferred.

The feature “visible under blacklight” indicates that the coatings in accordance with the present invention are readily discernable by the naked eye of a (non-color blind) human observer when the brake disc is irradiated with ultraviolet “blacklight”. Visibility of a coating under blacklight is a function both of the difference in color between the coating and uncoated portions of the (normally charcoal gray) carbon composite body and of the spatial density of the zinc sulfide mineral that remains on the coated surfaces. Persons skilled in the art can readily determine whether a particular antioxidant coating meets this criterion of the present invention simply by applying it to a carbon composite base, and then looking at the coating under blacklight lighting to see whether the coating is readily visible—that is, visible to the extent that its appearance on any portion of the surface of the (dark gray) composite article is apparent.

In accordance with the present invention, at some stage of the manufacturing process, the working surface of the brake disc may be partially covered by a layer of antioxidant composition containing zinc sulfide. The terminology “working surface of the brake disc” refers to that portion of the brake disc that frictionally engages with a brake pad during a braking operation. In accordance with the present invention, the entire working surface of the brake disc would be visually inspected under black light in order to identify whether any portion of the working surface of the brake disc has been contaminated by antioxidant composition.

The “working surface” of the brake disc should present the maximum possible frictional properties to the brake pad or mating brake disc. Accordingly, the present invention contemplates processing the brake disc, before incorporating it into a brake system, to remove any antioxidant composition from the working surface of the disc. In accordance with the present invention, this antioxidant layer removal step, for example utilizing a sanding procedure, is facilitated by the presence of the recited amount of zinc sulfide in the antioxidant layer.

The production of carbon-carbon composite materials, including brake friction materials, has been described extensively in the prior art. One commonly used production method comprises molding a carbon fiber composite with a carbonizable resin, e.g. a phenolic resin, carbonizing the composite “preform”, and then densifying the resulting porous material using chemical vapor infiltration (CVI) and/or resin impregnation processes. Another method comprises building up a fiber preform with textile materials and subsequently densifying the preform using a CVI process. Different structural types of carbon (graphitic, glassy, and pyrolytic) comprise the brake disc, which is somewhat porous. Further densification can be accomplished with, e.g., furfuryl alcohol infiltration or through incorporation into the carbon matrix of ceramic additives via infiltration with colloidal ceramics and their subsequent conversion to refractory materials.

Carbon-carbon brake disc friction performance is dictated by the carbon microstructure which arises from the manner in which the brake disc is manufactured. The amount of graphitization, for instance, can dramatically affect frictional and wear properties. Overall brake performance is particularly affected by the individual components, including fibers and types of matrix materials, at the friction surface.

One source of problems with these carbon composites is that they have low resistance to oxidation, by atmospheric oxygen, at elevated temperatures, that is, temperatures of 500° C. (932° F.) or higher. Oxidation not only attacks the surface of the carbon-carbon composites but also enters pores that invariably are present in such structures and oxidizes the carbon fibers adjacent to the pores and surfaces of the pores, thereby weakening the composites.

Exterior surfaces of carbon-carbon composites are therefore sometimes coated with a ceramic material such as silicon carbide to prevent entry of oxidizing agents such, as molecular or ionic oxygen from the atmosphere, into the carbon-carbon composites. Silicon carbide and other antioxidant coatings are described in detail in U.S. Pat. No. 4,837,073. The exterior surfaces of carbon-carbon composites may be, alternatively, coated with a glass-forming seal coat such as a boron or boron/zirconium substance. Borate glasses have also been used for the protection of carbon-carbon composites against oxidation. U.S. Pat. No. 5,208,099 describes antioxidant coatings that are formed from a SiO₂—B₂O₃ gel and/or sol having a SiO₂:B₂O₃ molar composition of 60-85:40-15. Borate glass antioxidant compositions are moisture-resistant and oxidation-resistant coatings composed of 40-80 weight-% B₂O₃, 5-30 weight-% SiO₂, 7-20 weight-% Li₂O, and 7-10 weight-% ZrO₂ are described in detail in U.S. Pat. No. 5,298,311.

U.S. Pat. No. 6,737,120 (Golecki) relates to carbon fiber or C-C composites that are useful in a variety of applications. Golecki teaches methods of protecting such composites against oxidation by coating them with fluidized-glass type mixtures. The fluidized-glass mixtures are maintained as liquid precursors and are applied to components formed of carbon fiber or C-C composites. Once coated with the precursors, the coated C-C components are heat-treated or annealed for one or more cycles through a series of gradual heating and cooling steps. This creates glass coatings having thicknesses of about 1-10 mils. The thicknesses of the glass coatings may be varied by varying the composition of the fluidized glass precursor mixtures, the number of application cycles, and/or the annealing parameters.

The Golecki patent teaches that the fluidized glass materials may comprise such materials as borate glasses (boron oxides), phosphate glasses (phosphorus oxides), silicate glasses (silicon oxides), and plumbate glasses (lead oxides). These glasses may include phosphates of manganese, nickel, vanadium, aluminum, and zinc, and/or alkaline and alkaline earth metals such as lithium, sodium, potassium, rubidium, magnesium, and calcium and their oxides, and elemental boron and/or boron compounds such as BN, B₄C, B₂O₃, and H₃BO₃. By way of example, Golecki discloses a boron-containing liquid fluidized glass precursor mixture that includes 29 weight-% phosphoric acid, 2 weight-% manganese phosphate, 3 weight-% potassium hydroxide, 1 weight-% boron nitride, 10 weight-% boron, and 55 weight-% water.

U.S. Pat. No. 6,455,159 (Walker and Booker) likewise relates to antioxidant systems for use with carbon-carbon composites and graphitic materials. The Walker and Booker patent has among its objectives the protection of antioxidant-coated carbon-carbon composites or graphite at elevated temperatures up to and exceeding 850° C. (1562° F.), as well as the reduction of catalytic oxidation at normal operating temperatures. Walker and Booker achieve these objectives by employing a penetrant salt solution which contains ions formed from 10-80 wt % H₂0, 20-70 wt % H₃PO₄, 0.1-25 wt % alkali metal mono-, di-, or tri-basic phosphate, and up to 2 wt % B₂O₃. Their penetrant salt solutions also include at least one of MnHPO₄.1.6H₂O, Al(H₂PO₄)₃, and Zn₃(PO₄)₂, in weight-percentages up to 25 wt %, 30 wt %, and 10 wt %, respectively.

The entire contents of U.S. Pat. No. 4,837,073, U.S. Pat. No. 5,208,099, U.S. Pat. No. 5,298,311, U.S. Pat. No. 6,737,120, and U.S. Pat. No. 6,455,159 are hereby expressly incorporated by reference.

Carbon-carbon composites are generally prepared from carbon preforms. Carbon preforms are made of carbon fibers, formed for instance of pre-oxidized polyacrylonitrile (PAN) resins. These fibers can be layered together to form shapes, such as friction brake discs, which shapes are then heated and infiltrated with methane or another pyrolyzable carbon source to form the C-C composite preforms. Carbon-carbon composites useful in accordance with the present invention typically have densities in the range of from about 1.6 g/cm³ through 1.9 g/cm³. Methods of manufacturing C-C composites are generally well known to those skilled in the art. A good reference in this area is: Buckley et al., Carbon-Carbon Materials and Composites, Noyes Publications, 1993. The entire contents of this publication are hereby expressly incorporated by reference.

For purposes of illustration only, the C-C composite component 10 may be fabricated from woven fabric panes of pitch-based Amoco P30X carbon fiber tows in a harness satin weave or from a pitch-based Nippon XNC25 in a plain weave. The tows are rigidized with a few weight-% carbon-containing resin, such as epoxy Novolac. The material is then carbonized at a temperature in the range of 800-1000° C. (1472-1832° F.) and densified by carbon CVD. The resulting material is then annealed in an inert gas at a temperature in the range of 1600-2600° C. (2912-4712° F.). This process creates a C-C composite component that is adaptable for use in high temperature environments when it is properly protected against oxidation. It is understood that the oxidation protective coating system of the present invention is applicable to C-C composite components regardless of how the C-C composite components are fabricated.

Visibility Testing

Blocks are made from carbon-carbon composite material designed to be used to make brake discs for F-15 fighter jets. The blocks are partially coated—and partially untreated—with antioxidant formulations as described in the following Table (percentages are by weight):

| “Blue” | “Green” | “Yellow” | “Colorless” |
|---|---|---|---|
| 17.3% ZnS | 20.0% ZnS | 7.0% ZnS | 2.0% ZnS |
| 42.7% H₃PO₄•H₂0 | 40.07% H₃PO₄•H₂0 | 42.7% H₃PO₄•H₂0 | 42.7% H₃PO₄•H₂0 |
| 23.6% H₂0 (de-ionized) | 23.6% H₂0 (de-ionized) | 23.6% H₂0 (de-ionized) | 33.6% H₂0 (de-ionized) |
| 1.4% H₃BO₃ | 1.4% H₃BO₃ | 1.4% H₃BO₃ | 1.4% H₃BO₃ |
| 10.1% KH₂PO₄ | 10.1% KH₂PO₄ | 20.4% KH₂PO₄ | 22.4% KH₂PO₄ |
| 5.0% CoAl₂O₄:MgO^{a} | 5.0% Cr₂O₄:TiO₂:ZnO^{b} | 5.0% (Ti,Ni,Sb)O₂^{c} | |

^{a}Ferro V-9250 Bright Blue
^{b}Ferro V-12600 Camouflage Green
^{c}Ferro V-9416 Yellow

Each of the coated blocks is examined under blacklight. The portion of the block that is coated with the antioxidant preparation is readily distinguishable from the portion of the block that is untreated with antioxidant. The antioxidant coating is then cured by heating them at 800° C. for one hour. Each of the cured coated blocks is examined under blacklight. The portion of the block that is coated with the antioxidant preparation is still readily distinguishable from the portion of the block that is untreated with antioxidant.

Finishing the Brake Disc

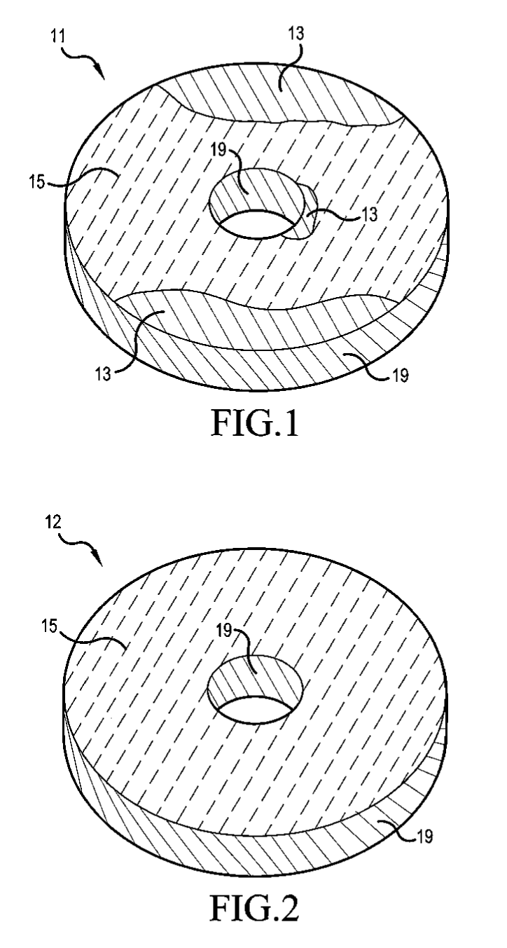

FIG. 1 illustrates a brake disc 11 in accordance with the present invention. In FIG. 1, carbon matrix 15 is covered on its outer and inner edges with antioxidant layers 19. Portions of the working surface of brake disc 11 are also covered with antioxidant layers 13, decreasing the fitness of the brake disc for service. FIG. 2 illustrates a brake disc 12 that has been manufactured from brake disc 11 of the present invention by the removal from its working surface, for example by sanding, of antioxidant layers 13.

The present invention has been described herein in terms of preferred embodiments. However, obvious modifications and additions to the invention will be apparent to those skilled in the relevant arts upon reading the foregoing description. It is intended that all such modifications and additions form a part of the present invention.

What is claimed is:

1. An antioxidant coating composition comprising from 10-75 wt % H₂0, 20-65 wt % H₃PO₄, 0.1-20 wt % alkali metal mono-, di-, or tri-basic phosphate, 0-2 wt % hydrated boron oxide, 0-18 wt % KH₂PO₄, 3-10 wt % of a transition metal oxide, and 1-20 wt % zinc sulfide.

2. The antioxidant coating composition of claim 1, comprising 2-10 wt % zinc sulfide.

3. The antioxidant coating composition of claim 1, comprising about 5 wt % zinc sulfide.

4. The antioxidant coating composition of claim 1, comprising from 20-25 wt % H₂O, 40-45 wt % H₃PO₄, 1-2 wt % H₃BO₃, 8-12 wt % KH₂PO₄, 4-7 wt % of a member selected from the group consisting of TiO₂ and CoCr₂O₄, and 2-10 wt % zinc sulfide.

5. The antioxidant coating composition of claim 4, wherein the transition metal oxide comprises CoCr₂O₄.

6. A brake disc comprising a carbon composite article, the surface of which article has been treated with an antioxidant coating which contains from about 1 through about 20 weight-% of zinc sulfide, wherein said zinc sulfide is visible under blacklight.

7. The brake disc of claim 4, wherein that antioxidant coating comprises from 10-75 wt % H₂0, 20-65 wt % H₃PO₄, 0.1-20 wt % alkali metal mono-, di-, or tri-basic phosphate, 0-2 wt % hydrated boron oxide, 0-18 wt % KH₂PO₄, 3-10 wt % of a transition metal oxide, and 1-20 wt % zinc sulfide.

8. A method for protecting a carbon composite friction article against oxidative weight loss, which method comprises treating the surface of the composite article with an antioxidant coating which contains from about 1 through about 20 weight-% of zinc sulfide, wherein the antioxidant coating is visible under blacklight.

9. The method of claim 8, which method comprises a preliminary step of configuring the carbon composite friction article as a brake disc.

10. The method of claim 8, which method comprises a subsequent step of removing said antioxidant coating from a friction surface of the brake disc.

11. The method of claim 10, wherein said antioxidant coating is removed from a friction surface of the brake disc by machining or by abrasion with a wire brush.
